(19) United States
(12) Patent Application Publication
(10) Pub. No.: US 2015/0350784 A1
(43) Pub. Date: Dec. 3, 2015

(54) MUSIC ADAPTIVE SPEAKER SYSTEM AND METHOD

(71) Applicant: Uma Satish Doshi, Portland, OR (US)

(72) Inventor: Uma Satish Doshi, Portland, OR (US)

(21) Appl. No.: 14/563,074

(22) Filed: Dec. 8, 2014

Related U.S. Application Data
(63) Continuation-in-part of application No. 14/508,253, filed on Oct. 7, 2014.
(60) Provisional application No. 61/995,148, filed on Apr. 3, 2014.
(60) Provisional application No. 62/122,775, filed on Oct. 28, 2014.

(51) Int. Cl. H04R 3/04

(52) U.S. Cl. CPC H04R 3/04

(57) ABSTRACT

A music adaptive speaker system and method. A musical electrical signal is separated into at least two components for input, respectively, to at least two loudspeaker drivers using at least one signal-separating cross-over point having a controllable frequency or frequency range. A music-adaptive cross-over point is identified for the musical electrical signal, and the frequency or frequency range of the signal-separating cross-over point is controlled based at least in part on the music-adaptive cross-over point.

### RELATED APPLICATIONS

The present application claims the benefit of U.S. provisional application Ser. No. 61/995,148 filed Apr. 3, 2014, and U.S. provisional application Ser. No. 62/122,775 filed Oct. 28, 2014, both of which are incorporated by reference herein in their entireties, and is a continuation-in-part of pending U.S. non-provisional application Ser. No. 14/508,253 filed Oct. 7, 2014, which is also incorporated by reference herein in its entirety.

### FIELD OF THE INVENTION

The present invention relates to speaker systems, which employ loudspeakers for reproducing sounds generally, and music particularly, from electrical signals.

### BACKGROUND

A “loudspeaker” is a transducer or combination of transducers that converts time varying electrical signals to sound waves. Each transducer is commonly referred to as a “driver” or “loudspeaker driver.”

By far the most common type of driver is the “dynamic speaker,” which uses a thin cone or diaphragm of a lightweight material (such as paper) that is caused to vibrate in response to the interaction of a likewise vibrating electrical current passing through a coil exposed to a permanent magnetic field, according to the principle of electromagnetic induction. Alternative driver technologies have also been employed.

The range of normal human hearing is about 15-18,000 cycles per second or Hz, but it is not practical to provide a single driver that has a substantially flat frequency response over such a wide range. Therefore, particularly if they are used for producing or reproducing music, multiple drivers are typically used, with each driver dedicated to a particular sub-set of the whole frequency range. For example, it is common to provide three different types of drivers in a single loudspeaker enclosure, known as “woofers,” for producing or reproducing sounds in the range of about 40-1000 Hz, “tweeters” for producing or reproducing sounds in the range of about 2,000-20,000 Hz, and “mid-range,” for producing or reproducing sounds within the range 300-5,000 Hz. More sophisticated systems may include “sub-woofers” and “super-tweeters,” for producing or reproducing sounds at lower and higher frequencies, respectively, than woofers and tweeters.

Generally, the physical size of a driver correlates with the frequency range to which that driver is suited. For example, producing sound at higher frequencies requires a diaphragm that has a low mass and can therefore move rapidly. A diaphragm can be made small to satisfy this requirement at high frequencies, where less air needs to be moved with each stroke of the diaphragm to maintain a particular level of output power. By contrast, producing sound at lower frequencies requires moving more air with each stroke to maintain the same power level, which requires a larger and therefore more massive diaphragm.

An electrical circuit called a “cross-over network,” which may be “passive” or “active,” is used to separate the incoming electrical signal into the different frequency ranges that are suitable for input to each type of driver. Cross-over networks are typically hard-wired for the drivers which they serve, based on the frequencies for which the drivers are designed.

### SUMMARY

A music adaptive speaker system and method is disclosed herein.

A music adaptive speaker system according to the invention has at least two loudspeaker drivers for transforming respective electrical inputs to respective acoustical outputs, a cross-over network configured to receive a musical electrical signal representative of a work of music, and separate the musical electrical signal into at least two components for input, respectively, to the at least two loudspeaker drivers using at least one signal-separating cross-over point having a controllable frequency or frequency range, a cross-over point identifying system configured to identify a music-adaptive cross-over point for the musical electrical signal, and a cross-over network control system configured to control the cross-over network so that the frequency or frequency range of the signal-separating cross-over point is based at least in part on the music-adaptive cross-over point.

The cross-over network control system is preferably configured to control the cross-over network so that the frequency or frequency range of the signal-separating cross-over point is substantially the same as the music-adaptive cross-over point.

The cross-over point identifying system may be configured to identify a category of music for the musical electrical signal.

Where the musical electrical signal is obtained from first data included in an electronic data file or stream, the cross-over point identifying system may be configured to determine the cross-over point of the musical electrical signal from second data included in the electronic data file or stream that are metadata for the first data.

The second data may be specified, at least in part, by a person or persons who created the work of music.

The cross-over point identifying system may be configured to determine a signature of the musical electrical signal and compare the signature of the musical electrical signal with one or more candidate signatures for works of music representative of, respectively, a plurality of distinct candidate categories of music.

Where a first signal f₁(t) is a time varying amplitude representation of a first work of music associated with the musical electrical signal, and a second signal f₂(t) is a time varying amplitude representation of a second work of music associated with one of the candidate categories of music, the cross-over network control system may be configured to perform respective frequency transformations of the signals f₁(t) and f₂(t), thereby obtaining respective first and second frequency varying functions F₁(ω) and F₂(ω), derive first and second magnitude functions M₁(ω) and M₂(ω) from, respectively, the functions F₁(ω) and F₂(ω), the magnitude functions being based on the magnitudes of the functions F₁(ω) and F₂(ω), fit to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions, compute modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of (ω), compare the modified calming functions MC₁(ω) and MC₂(ω) including compute one or more measures of difference therebetween, and, if the one or more measures of difference are within acceptable limits, identify the category of the musical electrical signal, at least in part, by identifying the first work of music as being in the same category as the second work of music.

A music adaptive speaker method according to the invention includes receiving a musical electrical signal representative of a work of music, identifying a music-adaptive cross-over point for the musical electrical signal, separating the musical electrical signal into at least two components using at least one signal-separating cross-over point having a controllable frequency or frequency range, and controlling the cross-over network so that the frequency or frequency range of the signal-separating cross-over point is based at least in part on the music-adaptive cross-over point.

The method provides for using the signal-separating cross-over point in a cross-over network that provides the at least two components as input, respectively, to at least two loudspeaker drivers for transforming the components into respective acoustical outputs.

The cross-over network is preferably controlled so that the frequency or frequency range of the signal-separating cross-over point is substantially the same as the music-adaptive cross-over point.

The step of identifying a music-adaptive cross-over point may include identifying a category of music for the musical electrical signal.

The musical electrical signal may be obtained from first data included in an electronic file or file stream, in which case the step of identifying a music-adaptive cross-over point may include determining the music-adaptive cross-over point from second data included in the electronic file or file stream that are metadata for the first data.

The second data may be specified, at least in part, by a person or persons who created the work of music.

The step of identifying a music-adaptive cross-over point may include determining a signature of the musical electrical signal, and comparing the signature of the musical electrical signal with one or more candidate signatures for works of music representative of, respectively, a plurality of distinct candidate categories of music.

Where a first signal f₁(t) is a time varying amplitude representation of a first work of music associated with the musical electrical signal, and a second signal f₂(t) is a time varying amplitude representation of a second work of music associated with one of the candidate categories of music, the method may further include performing respective frequency transformations of the signals f₁(t) and f₂(t), thereby obtaining respective first and second frequency varying functions F₁(ω) and F₂(ω), deriving first and second magnitude functions M₁(ω) and M₂(ω) from, respectively, the functions F₁(ω) and F₂(ω), the magnitude functions being based on the magnitudes of the functions F₁(ω) and F₂(ω), fitting to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions, computing modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of (ω), comparing the modified calming functions MC₁(ω) and MC₂(ω) including computing one or more measures of difference therebetween, and, if the one or more measures of difference are within acceptable limits, the step of identifying a category of music for the musical electrical signal may include identifying the first work of music as being in the same category as the second work of music.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF DRAWINGS

FIG. 1 is a block diagram of a computer system for categorizing music which was described in the present inventor's U.S. patent application Ser. No. 14/508,253.

FIG. 2 is a flow chart of steps which the computer system of FIG. 1 is programmed to perform as described in the U.S. patent application referred to in connection with FIG. 1.

FIGS. 3-6 are plots of music signatures achieved by performance of the steps charted in FIG. 2 for various artists, in arbitrary units of magnitude (ordinate) and frequency (abscissa).

FIG. 7 is a plot comparing a number of different music signatures achieved by performance of the steps charted in FIG. 2 for various artists and types of music, in arbitrary units of magnitude (ordinate) and frequency (abscissa).

FIG. 8 is a block diagram of a music adaptive speaker system according to the present invention.

### DETAILED DESCRIPTION OF PREFERRED EMBODIMENTS

The present invention makes use of a prior invention by the same inventor, for a method and system for music recommendation, which is the subject of a pending U.S. patent application Ser. No. 14/508,253, filed Oct. 7, 2014. This prior invention will be described first.

The prior invention provides generally for discerning similarities in works of authorship that allow for usefully categorizing them.

The term “work of authorship,” or simply “work,” refers to the categories of copyright eligible subject matter defined in 35 U.S.C. §102(a). Works of authorship are distinct from the “useful” arts that are the subject matter of patents, and are often utilized for entertainment. For purposes herein, it is not necessary that a work have a human author.

The term “music” encompasses those categories of works of authorship known as sound recordings and musical works, as well as the music accompanying a dramatic work or a motion picture or other audiovisual work.

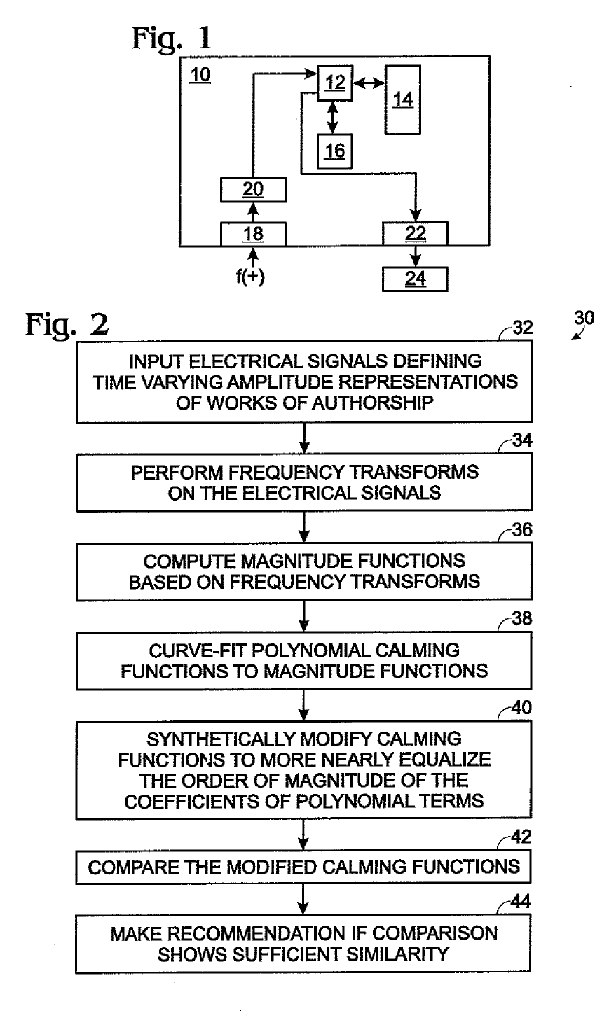

FIG. 1 shows a music categorizing computer system 10 that is preferred for use with the present invention. The system 10 is programmed to perform a number of steps of a method that is useful for categorizing music, as described below. It should be understood, however, that other music categorizing systems could be used, such as systems relying wholly on classification decisions made by human listeners, and systems such as Pandora Media's “Music Genome Project.”

The computer system 10 may employ any number of individual computers connected to each other as desired, such as through a local area network (LAN) or a wide area network (WAN) such as the Internet. But the system 10 may advantageously employ just one computer which may be a standard PC or Mac. Somewhere in the system 10 there is a processing unit 12, a storage memory 14 for storing data and data processing instructions, a working memory 16 which may be part of the storage memory for performing the stored data processing instructions on the stored data, a data input bus 18 for receiving the data, an analog to digital converter 20 for transforming the data to digital form if the data are not already being presented in digital form, and a data output bus 22 for outputting data processed by the system.

From the data output bus 22, the data may be transmitted to another computer system, or to a data rendering device 24 such as a display screen or printer for rendering the data so that the data can be visually perceived.

The computer system 10 can be programmed by a person of ordinary skill in the computer programming arts to perform the functions described herein.

The system 10 takes as input signals that are representative of the works of authorship under consideration. Typically, the signals will be electrical signals, but they could be optical signals or any other type of signal the computer system 10 is capable of processing. The signals can also be in either digital or analog form.

Playing a sound recording, or motion picture or other audiovisual work, or performing a musical work or dramatic work, produces sound waves. The sound waves may be transformed into an electrical signal by use of a microphone. The sound waves could also be transformed into any other type of signal that the computer system 10 is capable of processing.

Music is, however, generally originally fixed in a visually perceptible form, such as sheet music. In such form it may be translated into representative signals that can be processed by the computer system 10 without the need to create or reproduce any sounds.

In either case, works of music will be referred to generally hereinafter as aurally perceived works because that is how such works are typically enjoyed.

A signal has a time-varying amplitude f(t). For comparing two works, two such signals will be required, which may be referred to as f₁(t) and f₂(t). The signals will ordinarily be digitized for processing within the computer system 10.

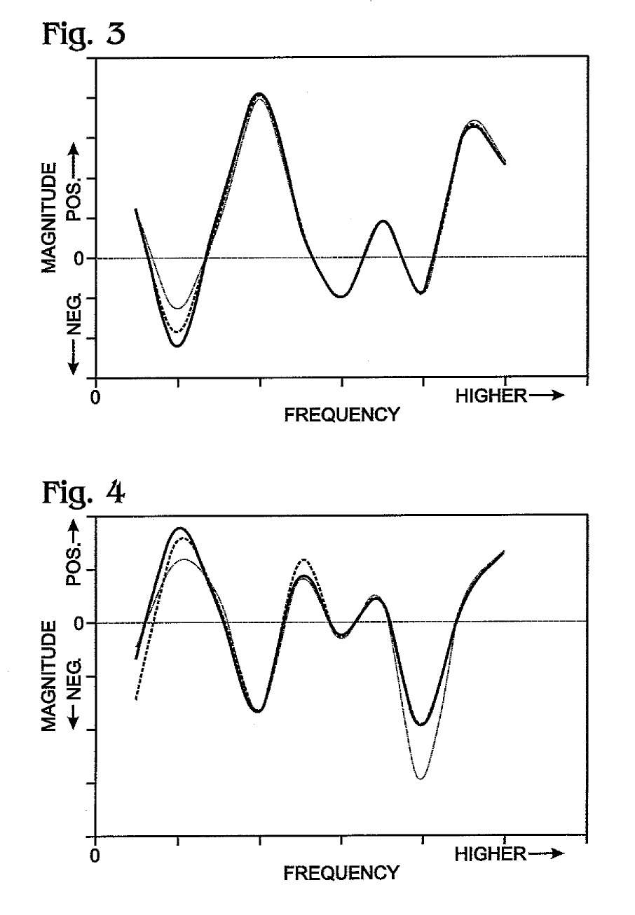

FIG. 2 shows how the computer system 10 may process the signals f₁(t) and f₂(t), by performing the following steps of a music categorizing method 30.

In a step 32, the signals f₁(t) and f₂(t) are provided to the computer system 10.

In a step 34, a “frequency transform” is performed on each of the signals f₁(t) and f₂(t).

There are a number of different frequency transforms that could be used. The Fourier series and the Fourier transform are probably the two such transforms that are the most famous, but there are also the discrete Fourier transform, the Fast Fourier transform, the LaPlace transform, the short-time Fourier transform, the cosine transform, and the wavelet transform, to name a few.

In general, a frequency transform of a function f(a), where the variable “a” could be either a time variable “t” or one or more spatial variables “x,” “y,” and “z,” will be defined broadly for purposes herein to comprise the sum Σ(ω) of a series of orthonormal basis functions of varying frequencies (ω) multiplied by respective coefficients, where the coefficients are computed so as to minimize the mean-square error between f(a) and Σ(ω). It may be noted that this definition allows for the sum of the series becoming an integral in the limit where the difference in the frequencies of the respective basis functions goes to zero.

The orthonormal basis functions may be, more specifically, periodically varying in (ω) such as in the Fourier transform, with which good results have been obtained using the software marketed as MATLAB® by the MathWorks corporation, headquartered in Natick, Mass.

The output of the transforming function step 30 is two functions F₁(ω), F₂(ω), corresponding respectively to f₁(t), f₂(t).

Next, in a step 36, magnitude functions M₁(ω) and M₂(ω) are computed, respectively, from the transform functions F₁(ω) and F₂(ω). The magnitude functions are “based on” the magnitudes of the transform functions, meaning that each magnitude function is derived, at least in part, from the magnitude of the respective transform function. For example, a magnitude function 1+|ω| is based on the magnitude of (ω). However, the magnitude functions are preferably simply proportional to the magnitudes of the respective transform functions.

In the general case where a transform function F(ω) may have either or both real and imaginary parts, the magnitude of F(ω) is [Re(F(ω))²+Im(F(ω))²]^{1/2}.

In the case of aurally perceived works, it is important that ears are sensitive to the power represented in the signals f(t), so in such cases the magnitude functions are preferably based on the magnitudes of the transform function by squaring the magnitudes of the transform functions.

Next, in a step 38, calming functions C₁(ω) and C₂(ω) are computed, respectively, from the magnitude functions M₁(ω) and M₂(ω) by curve-fitting. Particularly, each calming function C(ω) includes a sum of terms of varying powers of the variable (ω):
C₀ω⁰+C₁ω¹+C₂ω²+C₃ω³ . . . +Cₙωⁿ

The purpose of the calming functions C(ω) is to impose, on the respective magnitude functions, a limited number “n” of inflection points, where the number, location, and/or magnitude of the inflection points define a “signature” of the sound recordings represented by the calming functions. The C₀ ω⁰ term may be ignored for purposes of discerning inflection behavior, so the essential terms of the calming function for purposes of signature analysis are:
C₁ω¹+C₂ω²+C₃ω³ . . . +Cₙωⁿ

It has been found that for sound recordings, good results may be obtained with “n”=6, with somewhat better results with “n”=9, with still higher values of “n” providing for rapidly diminishing returns. Preferably, “n” is at least four, and more preferably it is at least five, and is less than 12.

Each calming function has a term of the same order of magnitude of (ω), so each term of one of the calming functions C₁(ω), C₂(ω) corresponds to a unique one of the terms of the other of the calming functions C₂(ω), C₁(ω),

While integral exponents are preferably used to define the powers of (ω) in the terms of the calming functions, this is not essential, e.g., the exponents 1, 2, 3, . . . etc. could be 1.1, 2.1, 3.1, . . . etc.

Also while evenly spaced exponents such as 1, 2, 3, . . . etc. or 1.1, 2.1, 3.1, . . . etc. are preferably used to define the powers of (ω) in the terms of the calming functions, this is not essential; the exponents could be unevenly spaced, such as 1.1, 2.3, 4.2, . . . etc.

Next, in a step 40, the calming functions C(ω) are synthetically modified to more nearly equalize the orders of magnitude of the coefficients C of non-zero powers of (ω), i.e. the coefficients C₁, C₂, C₃, . . . Cₙ.

Preferably, the coefficients Cₙ are modified to have the same order of magnitude. This may be ensured by factoring each of them into two respective parts A and B, where parts A will all be numbers greater than or equal to 1 and less than a base (or radix) that is the same for all the coefficients, and parts B will be the base raised to various powers, and dividing each coefficient by its respective part B.

For example, considering the term C₂ω², suppose C₂=1.8·10⁻⁵, the base in this example being ten. Then part A for the coefficient C₂ equals 1.8 and part B for the coefficient C₂ equals the base ten raised to the power −5, and the coefficient C₂ is modified by dividing it by 10⁻⁵ to make it equal to 1.8. That is, C₂=1.8·10⁻⁵ is modified to become just 1.8, i.e., the coefficient of the coefficient.

The calming functions as modified in step 40 may be referred to as modified calming functions MC(ω). Summarizing, the modified calming functions maintain the differences between terms specified by the coefficients of the coefficients, while at least decreasing, and preferably eliminating entirely, differences in the orders of magnitude of the coefficients.

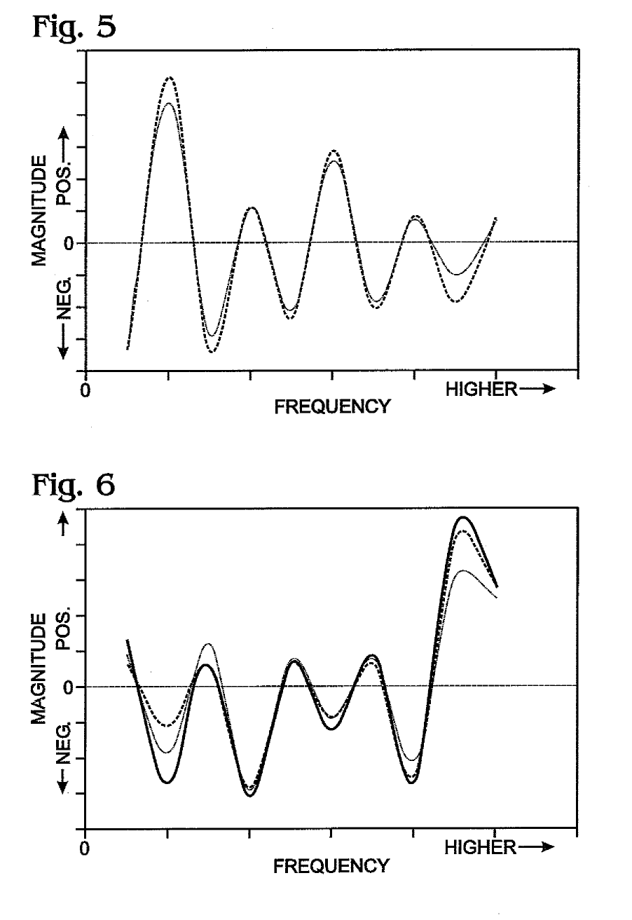

The modified calming functions MC(ω) are recognized according to the invention as “signatures” of the works represented by the original signals f(t). FIGS. 3-7 show such signatures achieved by use of the method 30 for aurally perceived works, more particularly sound recordings, using Fourier transforms in step 34, squaring the magnitudes in step 36, and fully equalizing the orders of magnitude of the coefficients of the calming functions in step 40. It may be observed in FIGS. 3-7 that the signatures for different sound recordings by the same artist differ only slightly, whereas the signatures for different artists differ greatly, and so it appears that the method 30 provides a simple yet powerful means of discerning similarities in sound recordings that are likely to be important for judging a listener's musical preferences.

Returning to FIG. 2, the method 30 includes a step 42 of comparing the modified calming functions MC₁(ω) and MC₂(ω). It may be sufficient to visually compare signatures when the similarities and differences are as readily apparent as in FIGS. 3-7, but for analysis by the computer system 10, the signatures are compared analytically for whether they fall within acceptable limits. This can be done using any of a number of known mathematical techniques, as desired. For example, the computer system 10 may be programmed to specify limits on the frequency separation between corresponding inflection points of the modified calming functions, alone or in combination with specifying limits on the area between the two modified calming functions near the inflection points.

If the difference between two signatures is within acceptable limits, the signatures can be considered close enough for categorizing the works as being similar.

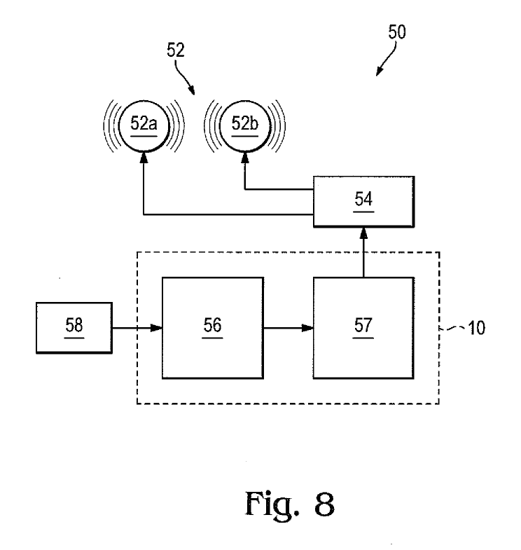

Turning to the present invention, FIG. 8 shows a speaker system 50 having at least two drivers 52, here 52a and 52b, a programmable or electronically configurable cross-over network 54, a cross-over point identifying system 56, and a control system 57 for controlling the cross-over network.

Speaker drivers are virtually always housed in speaker enclosures or cabinets to improve their acoustic performance. The drivers 52 would typically be housed together in the same enclosure, but this is not essential; drivers for use with the invention may be provided in separate enclosures including those provided in headsets and headphones, and drivers for use with the invention may be provided without enclosures, such as in earsets and earphones.

The speaker system 50, and particularly the cross-over network 54, receives desired electrical signals that are representative of works of music and that are used by listeners to hear the works of music, as input from one or more electronic devices 58 that produce the desired electrical signals. For example and without limitation, such devices may be music players of all types (analog and digital), televisions, computers, and cellular (a.k.a. mobile) phones. Hereinafter the term “sound signal output device” will refer broadly to any of such electronic devices.

The desired electrical signals may be input to a sound signal output device 58, or produced within the sound signal output device, in a number of different ways. For example, desired electrical signals may be broadcast over the air to the sound signal output device by a transmitter and be received by a receiver in the sound signal output device; desired electrical signals may be produced within the sound signal output device by streaming data from a medium such as a compact disc, or from a memory within the sound signal output device in which data have been downloaded, such as from an Internet website; and desired electrical signals may be obtained from data that are streamed, such as from an Internet web site, to the sound signal output device without storing the data in the sound signal output device.

The cross-over network 54 has at least one cross-over frequency or frequency range F (hereinafter “cross-over point”) which is defined for purposes herein as a frequency, or frequency range, below which at least a majority of the power in a desired electrical signal that is provided as input to the cross-over network 54 is directed to one driver, and above which at least a majority of the power in the same electrical signal is directed to a different driver.

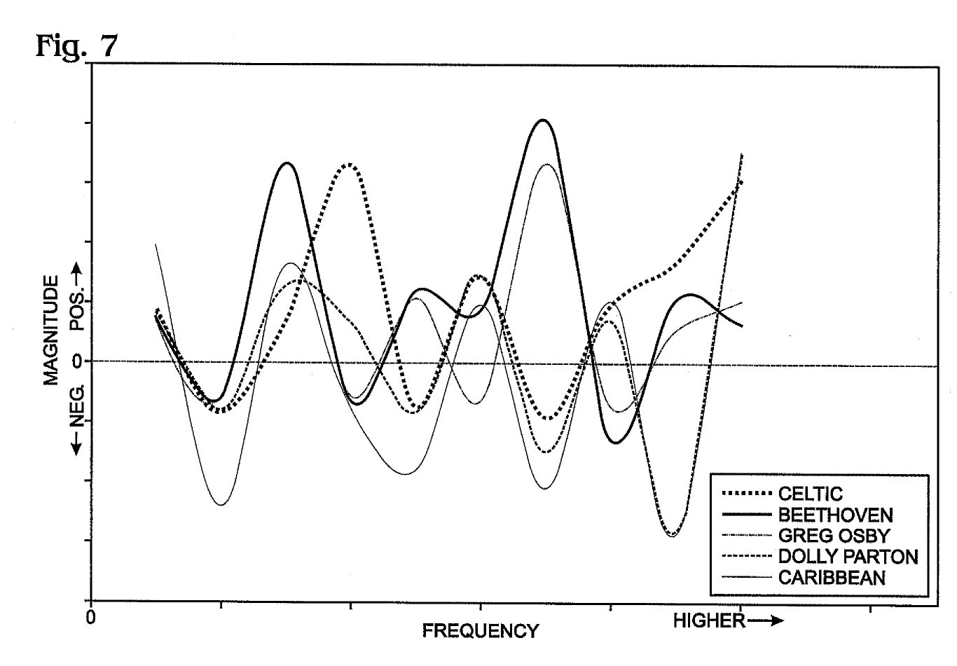

According to the present invention, the computer system 10 may be adapted to perform the function of the cross-over point identifying system 56 by categorizing a desired electrical signal that is being or will be provided as input to the cross-over network 54. For this purpose, the computer system 10 may have either created and/or stored, or may obtain access to (such as from an Internet web site), a library of signatures representative of various categories of music. For example, as a result of performing the method 30, FIG. 7 shows four categories of music which for discussion purposes may be referenced with a number “N;” such as N=1 for “Celtic” music, N=2 for music by “Beethoven,” N=3 for music by “Greg Osby,” N=4 for music by “Dolly Parton,” and N=5 for “Carribean” music.

The computer system 10 may be further adapted for use with the speaker system 50 to compare the desired electrical signal with the music represented by the N categories of music, such as by comparing a signature as described above for the desired electrical signal with one or more of the signatures representing the categories N, and identify a closest match. A closest match may be identified by any desired criteria, weighted in any way that is desired, but a least-squares fit between the signature of the desired electrical signal and one or more of the signatures for the music used to define the categories N will typically suffice.

The present inventor has recognized that it is generally desirable to set the cross-over points for different categories of music differently due to categorically based differences in the frequency content of the music. According to this recognition, the cross-over point identifying system 56 may be adapted to associate the works of music that are categorized in a given category N with a corresponding cross-over point F_{N}, and issue one or more commands to the programmable cross-over network 54 to set the cross-over point at F_{N}. For example, if the cross-over network 54 had previously been in a state in which the cross-over point was set at F_{N=4} for music by Dolly Parton, and the computer system 10 ascertains that the desired electrical signal has a closest match with N=5 for “Carribean” music, the computer system 10 may issue one or more commands to the cross-over network 54 to change the cross-over point from F₄ to F₅.

The computer system 10 may be adapted to perform the functions of both the cross-over point identifying system 56 and the control system 57, or the control system 57 may be implemented separately from the cross-over point identifying system as desired.

A desired cross-over point F_{N} may be selected empirically or heuristically, or it may be selected based on an analysis of the frequency content of one or more works of music falling within the particular category.

As will be understood by persons of ordinary skill, a cross-over network can be made programmable in any number of ways. One way is to implement the cross-over network 54 in software in the computer system 10 by use of standard digital signal processing techniques.

The drivers 52 are preferably contained within a single speaker enclosure, along with the computer system 10 and the programmable cross-over network 54, but can be in separate enclosures if desired without departing from the principles of the invention.

Ordinarily, the cross-over network 54 will divert (a) the low frequency portion of a desired electrical signal to one or more substantially identical drivers that are adapted to produce or reproduce sounds at low frequencies, (b) the mid-range frequency portion of the desired electrical signal to one or more substantially identical drivers that are adapted to produce or reproduce sounds at mid-range frequencies, and (c) the high frequency portion of the desired electrical signal to one or more substantially identical drivers that are adapted to produce or reproduce sounds at high frequencies. However, the invention contemplates the possibility that the cross-over network may provide for cross-over points F_{N} that are different for, or may select and/or de-select, particular drivers within a group of drivers that are all adapted to produce or reproduce sounds at substantially the same frequencies. This may be desirable, for example, where the drivers are not identical (e.g., they could be the same size and type but be provided by different manufacturers), and/or where their placement within an enclosure or relative to the listener may affect their sound or the listener's perception of their sound.

Herein, a first cross-over point is “substantially the same” as a second cross-over point if the two cross-over points do not vary in frequency or frequencies by more than 10%; or preferably 5%, or more preferably 1%.

It was noted above that music categorizing systems other than that provided by the computer system 10 as described above could be used with the invention, including systems relying wholly on classification decisions made by human listeners. In that regard, it is recognized as being particularly desirable to have the artists who themselves created the music make such classification decisions.

Further, artists, or others knowing of the existence of music adaptive speaker systems according to the invention may choose to identify cross-over frequencies as an alternative to identifying, or having listeners rely on music categorizing systems to identify, a category of music from which the cross-over frequencies are determined.

Still further, regardless of the source of a classification decision or identification of a cross-over frequency, or the method(s) used, the classification or cross-over frequency may be specified by metadata for the data used to produce the desired electrical signal, so that the music categorizing system may simply read the metadata to determine how to control the cross-over network.

It is to be understood that, while a specific music adaptive speaker system has been shown and described as preferred, variations may be employed without departing from the principles of the invention, and that the scope of the invention is defined and limited only by the claims which follow.

1. A music adaptive speaker system, comprising:
at least two loudspeaker drivers for transforming respective electrical inputs to respective acoustical outputs;
a cross-over network configured to receive a musical electrical signal representative of a work of music, and separate the musical electrical signal into at least two components for input, respectively, to the at least two loudspeaker drivers using at least one signal-separating cross-over point having a controllable frequency or frequency range;
a cross-over point identifying system configured to identify a music-adaptive cross-over point for the musical electrical signal; and
a cross-over network control system configured to control the cross-over network so that the frequency or frequency range of the signal-separating cross-over point is based at least in part on the music-adaptive cross-over point.

2. The system of claim 1, wherein the cross-over network control system is configured to control the cross-over network so that the frequency or frequency range of the signal-separating cross-over point is substantially the same as the music-adaptive cross-over point.

3. The system of claim 2, wherein the cross-over point identifying system is configured to identify a category of music for the musical electrical signal.

4. The system of claim 1, wherein the cross-over point identifying system is configured to identify a category of music for the musical electrical signal.

5. The system of claim 2, wherein the musical electrical signal is obtained from first data included in an electronic data file or stream, and wherein the cross-over point identifying system is configured to determine the cross-over point of the musical electrical signal from second data included in the electronic data file or stream that are metadata for the first data.

6. The system of claim 5, wherein the second data are specified, at least in part, by a person or persons who created the work of music.

7. The system of claim 1, wherein the musical electrical signal is obtained from first data included in an electronic file, and wherein the cross-over point identifying system is configured to determine the cross-over point of the musical electrical signal from second data that are metadata, relative to the first data, included in the electronic file.

8. The system of claim 7, wherein the musical electrical signal represents a work of music, wherein the second data are specified, at least in part, by a person or persons who created the work of music.

9. The system of claim 1, wherein the cross-over point identifying system is further configured to determine a signature of the musical electrical signal and compare the signature of the musical electrical signal with one or more candidate signatures for works of music representative of, respectively, a plurality of distinct candidate categories of music.

10. The system of claim 9, wherein a first signal f₁(t) is a time varying amplitude representation of a first work of music associated with the musical electrical signal, wherein a second signal f₂(t) is a time varying amplitude representation of a second work of music associated with one of the candidate categories of music, and wherein the cross-over network control system is further configured to:
perform respective frequency transformations of the signals f₁(t) and f₂(t), thereby obtaining respective first and second frequency varying functions F₁(ω) and F₂(ω);
derive first and second magnitude functions M₁(ω) and M₂(ω) from, respectively, the functions F₁(ω) and F₂(ω), the magnitude functions being based on the magnitudes of the functions F₁(ω) and F₂(ω);
fit to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions;
compute modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of (ω);
compare the modified calming functions MC₁(ω) and MC₂(ω) including compute one or more measures of difference therebetween; and
wherein, if the one or more measures of difference are within acceptable limits, identify the category of the musical electrical signal, at least in part, by identifying the first work of music as being in the same category as the second work of music.

11. A music adaptive speaker method, comprising:
receiving a musical electrical signal representative of a work of music;
identifying a music-adaptive cross-over point for the musical electrical signal;
separating the musical electrical signal into at least two components using at least one signal-separating cross-over point having a controllable frequency or frequency range; and
controlling the cross-over network so that the frequency or frequency range of the signal-separating cross-over point based at least in part on the music-adaptive cross-over point.

12. The method of claim 11, further comprising using the signal-separating cross-over point in a cross-over network that provides the at least two components as input, respectively, to at least two loudspeaker drivers for transforming the components into respective acoustical outputs.

13. The method of claim 12, further comprising controlling the cross-over network so that the frequency or frequency range of the signal-separating cross-over point is substantially the same as the music-adaptive cross-over point.

14. The method of claim 11, further comprising controlling the cross-over network so that the frequency or frequency range of the signal-separating cross-over point is substantially the same as the music-adaptive cross-over point.

15. The method of claim 14, wherein the step of identifying a music-adaptive cross-over point includes identifying a category of music for the musical electrical signal.

16. The method of claim 13, wherein the step of identifying a music-adaptive cross-over point includes identifying a category of music for the musical electrical signal.

17. The method of claim 12, wherein the step of identifying a music-adaptive cross-over point includes identifying a category of music for the musical electrical signal.

18. The method of claim 11, wherein the step of identifying a music-adaptive cross-over point includes identifying a category of music for the musical electrical signal.

19. The method of claim 14, further comprising obtaining the musical electrical signal from first data included in an electronic file or file stream, and wherein the step of identifying a music-adaptive cross-over point includes determining the music-adaptive cross-over point from second data included in the electronic file or file stream that are metadata for the first data.

20. The method of claim 19, wherein the second data are specified, at least in part, by a person or persons who created the work of music.

21. The method of claim 13, further comprising obtaining the musical electrical signal from first data included in an electronic data file or stream, and wherein the step of identifying a music-adaptive cross-over point includes determining the music-adaptive cross-over point from second data included in the electronic data file or stream that are metadata for the first data.

22. The method of claim 21, wherein the second data are specified, at least in part, by a person or persons who created the work of music.

23. The method of claim 11, further comprising obtaining the musical electrical signal from first data included in an electronic data file or stream, and wherein the step of identifying a music-adaptive cross-over point includes determining the music-adaptive cross-over point from second data included in the electronic data file or stream that are metadata for the first data.

24. The method of claim 23, wherein the second data are specified, at least in part, by a person or persons who created the work of music.

25. The method of claim 11, further comprising obtaining the musical electrical signal from first data included in an electronic file, and wherein the step of identifying a music-adaptive cross-over point includes determining the music-adaptive cross-over point from second data that are metadata, relative to the first data, included in the electronic file.

26. The method of claim 25, wherein the second data are specified, at least in part, by a person or persons who created the work of music.

27. The method of claim 12, wherein the step of identifying a music-adaptive cross-over point includes determining a signature of the musical electrical signal, and comparing the signature of the musical electrical signal with one or more candidate signatures for works of music representative of, respectively, a plurality of distinct candidate categories of music.

28. The method of claim 27, wherein a first signal f₁(t) is a time varying amplitude representation of a first work of music associated with the musical electrical signal, wherein a second signal f₂(t) is a time varying amplitude representation of a second work of music associated with one of the candidate categories of music, the method further comprising:
performing respective frequency transformations of the signals f₁(t) and f₂(t), thereby obtaining respective first and second frequency varying functions F₁(ω) and F₂(ω);
deriving first and second magnitude functions M₁(ω) and M₂(ω) from, respectively, the functions F₁(ω) and F₂(ω), the magnitude functions being based on the magnitudes of the functions F₁(ω) and F₂(ω);
fitting to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions;
computing modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of (ω);
comparing the modified calming functions MC₁(ω) and MC₂(ω) including computing one or more measures of difference therebetween; and
wherein, if the one or more measures of difference are within acceptable limits, the step of identifying a category of music for the musical electrical signal includes identifying the first work of music as being in the same category as the second work of music.

29. The method of claim 11, wherein the step of identifying a music-adaptive cross-over point includes determining a signature of the musical electrical signal, and comparing the signature of the musical electrical signal with one or more candidate signatures for works of music representative of, respectively, a plurality of distinct candidate categories of music.

30. The method of claim 29, wherein a first signal f₁(t) is a time varying amplitude representation of a first work of music associated with the musical electrical signal, wherein a second signal f₂(t) is a time varying amplitude representation of a second work of music associated with one of the candidate categories of music, the method further comprising:
performing respective frequency transformations of the signals f₁(t) and f₂(t), thereby obtaining respective first and second frequency varying functions F₁(ω) and F₂(ω);
deriving first and second magnitude functions M₁(ω) and M₂(ω) from, respectively, the functions F₁(ω) and F₂(ω), the magnitude functions being based on the magnitudes of the functions F₁(ω) and F₂(ω);
fitting to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions;
computing modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of (ω);
comparing the modified calming functions MC₁(ω) and MC₂(ω) including computing one or more measures of difference therebetween; and
wherein, if the one or more measures of difference are within acceptable limits, the step of identifying a category of music for the musical electrical signal includes identifying the first work of music as being in the same category as the second work of music.
